(19) United States
(12) Patent Application Publication
(10) Pub. No.: US 2020/0387603 A1
(43) Pub. Date: Dec. 10, 2020

(54) DEVICE PROTECTION BASED ON PREDICTION AND CONTEXTUAL ANALYSIS

(71) Applicant: International Business Machines Corporation, Armonk, NY (US)

(72) Inventors: Komminist Weldemariam, Ottawa (CA); Abdigani Diriye, Nairobi (KE); Shikhar Kwatra, Durham, NC (US)

(21) Appl. No.: 16/431,181

(22) Filed: Jun. 4, 2019

(51) Int. Cl. G06F 21/55; G06N 5/02

(52) U.S. Cl. CPC G06F 21/554; G06N 5/02

(57) ABSTRACT

A user's cognitive state of a user who is using a device is estimated. Based on past history of use of the device and the estimated user's cognitive state, a possible deleterious user action on the device is detected. Based on the detected possible deleterious user action on the device, the device can be caused to perform an amelioration action for time period P.

### BACKGROUND

The present application relates generally to computers and computer applications, and more particularly to protecting a device such as, but not limited to, a computer, smart phone, another smart device, automatic or autonomous device or another device.

A device can break as a result of a behavior of its user or another human, for instance, accidentally or intentionally. For example, a user may make a decision when using an app, operating system, piece of software, smartphone, or other features on a device, which may have a potentially deleterious effect on the device, app, or the user.

### BRIEF SUMMARY

A system, in one aspect, may include a hardware processor. A memory device may be operably coupled to the hardware processor. The hardware processor may be operable to estimate a user's cognitive state of a user who is using a device. At least based on past history of use of the device and the estimated user's cognitive state, the hardware processor may be further operable to detect a possible deleterious user action on the device. At least based on the detected possible deleterious user action on the device, the hardware processor may be further operable to cause the device to perform an amelioration action for a time period P.

A computer-implemented method, in one aspect, may include estimating a user's cognitive state of a user who is using a device. The method may also include, at least based on past history of use of the device and the detected user's cognitive state, detecting a possible deleterious user action on the device. The method may further include, at least based on the detected possible deleterious user action on the device, causing of performing an amelioration action for a time period P.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating a method in one embodiment, which characterizes context and performs an ameliorative action based on a decision.

FIG. 2 illustrates system architecture in one embodiment for self-protection of a device or system performed based on prediction and contextual analysis.

FIG. 3 illustrates an example of prediction phases and output in one embodiment.

FIG. 4 is a flow diagram illustrating a method in one embodiment.

FIG. 5 is a diagram showing components of a system in one embodiment that can provide device protection, for example, a self-protection.

FIG. 6 illustrates a schematic of an example computer or processing system that may implement a system in one embodiment.

FIG. 7 illustrates a cloud computing environment in one embodiment.

FIG. 8 illustrates a set of functional abstraction layers provided by cloud computing environment in one embodiment of the present disclosure.

### DETAILED DESCRIPTION

A system, method and technique are disclosed, which can automatically detect and take an action to manage deleterious user actions on a device (e.g., a smartphone, tablet or another device) or system based on prediction and contextual analysis. The system may estimate a user's cognitive state (e.g., anger or distraction level) and or behavior (e.g., erratic behavior), learn possible deleterious user actions based on past history of use of a system or device (for a particular user or user cohort). Based on the estimation, the system allows or causes the device to take an amelioration action for time period P. For instance, the device can take a system self-protection action. As an example, an icon on a graphical user interface (GUI) may disappear when the user's estimated anger level exceeds a threshold, based on a history of GUI use by the user and/or a set of users in a cohort. A method that enables a device to share user's cognitive state and the amelioration action a device has taken to prevent damage to the device with one or more other nearby devices is also disclosed.

The cognitive or behavior state may include, but is not limited to, any of: anger, a level of distraction, disregard for device “wellbeing,” inebriation, drowsiness, undesired behavior toward a device or app, and/or others.

The amelioration action may include, but is not limited to, any of: an icon being removed from a GUI, features temporarily or partially being removed from an app, features being deactivated, features being password protected, features begin shielded in a robot embodiment, apps or apps' shortcuts being removed from locations that can be accessible relatively easily, sensitive content (e.g., emails, documents, data) being hidden or requiring another step to fully access the content, increasing distance from a user to avoid physical contact, voice and/or tone being changed (e.g., of a speaking robot), and/or others.

In some embodiments, the system and/or method determine the time period duration P based on probabilistic estimation of undesired behavior to a device or system. The system and/or method may detect continuation of a dangerous user state and/or a probabilistic estimation of the level of cognitive or behavioral concern.

In some embodiments, the device and/or system may be, but are not limited to, a smartphone, an app running on a smartphone, embodied as a service robot, a toy, a robot, a car, an autonomous vehicle, a medical device, a word processor app, a web browser, and/or another.

In some embodiments, the action may optionally further include: asking for a password responsive to determining or detecting that a user is attempting to access a GUI button while in a certain estimated cognitive state, on an app and/or content on devices (e.g., messaging app, chat, email content, social network or blog context including notifications, etc.); encrypting content or portion of the content based on a risk factor of the content; transferring content to a secondary computing device; stopping synchronizing of on-device (local) content and/or content sources (and/or apps) with remote content sources (and/or apps); hiding content arrival (e.g., disabling showing of a notification); transferring content to another content format, e.g., based on the determined period of time T (e.g., by blurring an image, deducing quality of the content, etc.).

The deleterious user actions may lead to system or device inefficiency and/or, destruction. The deleterious user actions may further lead to an estimated loss or damage to data, documents, installed apps and/or software. In some embodiments, the past history of actions causing such device inefficiency and/or destruction may be stored in a database, for example, on a storage device.

In some embodiments, the system may automatically deactivate one or more commands for a period of time T (e.g., delete, cut, remove, drag-drop, etc.) from the user device or applications for a period of time. In some embodiments, the system may reactivation of these commands, for example, using a completely automated public Turing test to tell computers and humans apart (CAPTCHA)-like challenge. Such a challenge poses or presents a question or test to the user. The system and/or method in some embodiments may generate a challenge based on learning one or more of the user's cognitive state or behavior, actions performed, history of interactions with one or more devices, and current user context, and any combinations thereof.

In some embodiments, the system and/or method may translate the user action into “garbage” command or a command that may be stored and easily accessed for later use when the user is in a preferred state. A listing of commands the user attempted while in an inebriated former state can be presented to the user, for instance, at the request of the user.

In some embodiments, a user may override the self-protection, and request that one or more missing (protected) features be returned, for instance, immediately. In some embodiments, if the risk level of accessing a feature is still deemed to be high, the system and/or method may prompt the user with a CAPTCHA-like challenge.

In some embodiments, the system and/or method may cause the device to change its modality into a “safe” mode based on cognitive understanding of the user. For instance, the system and/or may perform such cognitive understand by analyzing cognitive state, behavior and context, learning from past accidents by the user or a set of users (e.g., users in a group such as an organization, a demographic or another). In an embodiment of an implementation, the system and/or method may select GUI icons to be removed from a set of possible icons based on a risk assessment relating to possible use.

The system and/or method in some embodiments may perform understanding of the user cognitive state, with a confidence level C, for example, by analyzing real-time interaction, engagement pattern or sequence, facial expression (e.g., using inputs received from a front camera (or like image capturing device) of a user device such as a smartphone, from a nearby camera or another); analyzing a plurality of user activities that may include conversations (e.g., text messages, notifications, and emails received), joint analysis of phone calls received, or another; and inferring a distraction level (e.g., user has 10 open windows and is talking on the phone) based on the above analyses.

In some embodiments, the system and/or method may further learn (or estimate) the user cognitive state or behavior from the user situational context. Such learning or estimating may include predicting that a user is entering an interaction or conversation at particular time of the day; sensing that a user is exhibiting erratic or unusual behavior based on voice and/or speech recognition, crowd density and/or crowd sensing techniques, and/or another. The method of detecting situational context of the user and user cognitive context further may involve analyzing data received from a plurality of data sources such as mobile device built-in sensor (e.g., global positioning system (GPS), accelerometer, camera, microphone, etc.), crowd-sourced location information, data received from nearby computing (e.g., nearby mobile devices) and/or communication devices (e.g., Wi-Fi gateways, Beacon, network devices, etc.), and/or other devices such as camera, microphone. In some embodiments, a multi-layer neural network model or supervised machine learning model, for instance, logistic regression model with regularization can be used in order to understand and classify the relative state of the user and the capacity of the user to use the smart devices according to the user needs.

The capturing of the user information can be based on opt-in and opt-out basis, for example, with a user permission.

In some embodiments, input parameters that are fed to the system and/or method for the system and/or method to understand the cognitive state of the user with respect to an application (or device) being used can include, but are not limited to, one or more of, or any combinations of: Mood and cognitive state of the user (e.g., which can be monitored using wearable device and/or camera, or other devices); Physiological state, e.g., blood/chemical concentration level of the user; Time of the day; User's schedule and/or electronic calendar activity (e.g., determined from the user's electronic calendar); Conversation monitoring; and geo-spatial metrics

In some embodiments, these multi-dimensional set of matrix vectors are applied to a neural network model to establish the capability of the user to use the respective devices. Dynamic reinforcement feedback can also be fed into the system in order to determine the estimated time period T for the protective layer to be activated on the respective devices and/or to make an informed decision if there is a need to trigger a notification on the respective devices regarding the activity of the user. In some embodiments, at the same time, a decision can be made as to whether to cache the monitored activity in a database (e.g., a cloud database) to have a relevance check and improve the rigidity factor of the system.

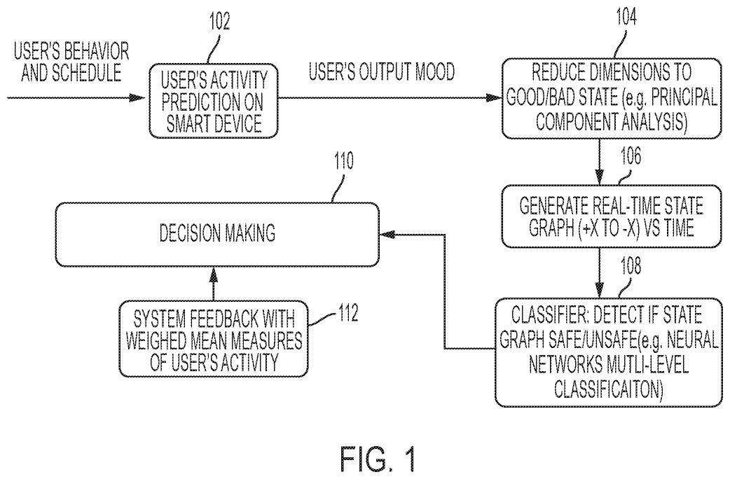

FIG. 1 is a diagram illustrating a method in one embodiment, which characterizes context and performs ameliorative action based on a decision. The method may include implementing or using a machine learning algorithm. The method may be performed by one or more hardware processors. At 102, based on a user's behavior and schedule, the method may predict a user's potential activity on a device such as a smartphone. For instance, the user's potential activity may be predicted based on past history which correlates user behavior with one or more activities the user (or a group of users) may have performed. An activity prediction can be correlated with user's mood profile to understand the engagement level and/or behavior of the user while executing an activity.

At 104, user's detected mood (e.g., based on the user behavior) can be reduced in dimensions such as “good” or “not good” state. In an example, the user's detected mood can include one or more of sad, frustrated, satisfied, excited, polite, impolite, sympathetic. A technique such as a Principal Component Analysis can be employed to reduce the dimension of the detected mood. In some embodiments, the processing at 102 and 104, which may gather mood state can be performed over time, for example, on a continual basis.

At 106, a real-time state graph can be generated that shows or indicates the user state over time, e.g., +x to −x versus (vs.) time. For example, the processing at 102 and 104 may be performed iteratively over time, for example in intervals of time such as every 1 second, 1 minute, etc. for a period of time, e.g., 5 minutes. Other time intervals and durations can be configured.

At 108, based on the real-time state graph, a classifier is run to classify the state graph as safe or unsafe. In one embodiment, as neural network that performs multi-level classification can be implemented and run.

At 110, based on the classification at 108, a decision is made to protect the device (user device such as a smart device or phone). In some embodiments, the method is executed by the device, and hence can determine whether it should self-protect itself.

At 112, the method may include receiving a feedback of the user activity, to further refine the decision making at 110. For instance, a feedback with weighed mean measures of user's activity may be received. In some embodiments, the method may include computing and/or training over time different mood variations of the user while predicting activities being conducted by the user. The mood variations can be normalized to arrive at a global maxima/minimum once feature pruning has been done and mood state has been determined based on the classifier.

As an example of an embodiment, consider that a user is using a laptop device (or another device such as a smartphone, smart device) daily and the device understands and monitors the contextual situation and user's activity. Such monitoring can be performed on an opt-in or opt-out basis, for example, with a permission of the user. Another user may start using the device, open an email application on the device, and start writing random words to a random recipient. The device monitors said another user's activity and determines that said another user's activity does not match with the user's activity (e.g., based on the contextual situation, way of typing, speed, touch, interaction with the person said another user writing an email to, etc.). The system and/or method (which may be running on the user's device) may create a protective overlay layer and lock the device, demand a response to a challenge or test, request a password to be entered, or another identification such as a biometric fingerprint of an authorized user to be entered, in order to reactivate the device.

As an example extension of the above-described example use case, once the activity of said another user is detected and the device understands that the characteristics and contextual situation are inconsistent with the user's characteristics, the overlay layer can also create a dynamic user interface (UI) or trigger a notification to the user (or another designated user) notifying the user of the suspicious activity and informing the user that the suspicious activity has been deliberately stopped for a sustained time period based on the user's history and geo-spatial temporal pattern, and would require the user's permission to continue with the activity. Such notification can be provided via the device itself, another device associated with the user, or combinations thereof. Once the specific time window is over, the user can access the device. For example, responsive to the time window or period expiring, the device can reactivate itself, or caused to be reactivated. The information with respect to the time, reason for deactivating the device and/or other information associated with the performed self-protection by the device (or activity blocked device) can be saved, for example, in the form of audio, video, contextual format, or another, in a database, for example, in a cloud-based database associated with the user.

As another example of an embodiment, while the user is texting (entering a text message) or conversing (e.g., engaged in chatting, video chatting, or another) via the device, and the user's words or expressions are not coherent, and/or the usual speech is not usual or deviates from the user's norm range based on history, the method can detect such a scenario based on contextual situation and/or cognitive heuristics, and take an ameliorative action mid-way to cancel the user activity and activate a protective overlay interface to disallow the user from further writing or conversing. The overlay interface can throw a temporary message on the user's devices or another device (such as a pop-up on the screen) and prevent the user from using the device for a period of time P. In some embodiments, the method can include providing access to the user temporarily to verify if the user has attained the user's usual state. In an example, an email “send” option may be deactivated and the message the user wrote may be saved in a draft for the user to view after the user is allowed access to the device.

In some embodiments, one or more wearable devices (e.g., a smartwatch, sensory headphone, neuro-signals capturing gear, etc.) can detect the health and related conditions of the user and notify one or more other devices, about the user's anomalous behavior. This can trigger the overlay layer to be activated on the linked devices (e.g., one or more other devices associated with the user or of another user) so that the user can be prevented from taking any dangerous action or performing any hazardous activity via the linked devices.

In some embodiments, the system and/or method may take into account recognition of selected emotion categories from a keyboard stroke pattern and/or an authentication of a specific group of users or cohort. In some embodiments, classifiers or classification algorithms like Simple Logistics, Sequential Minimal Optimization (SMO), Multilayer Perceptron, Random Tree, J48 and BF Tree can be used to analyze the selected features from keyboard stroke pattern and predict the mood variations of a specific user. The typing parameters like flight time, dwell time, typing speed and clustering of keys can be used to create identity of authentic user and if the deviation is more than a specific risk threshold, the system and/or method may prevent the user from executing any activity on the device, which may be deemed dangerous.

In some embodiments, an ameliorative action can be determined based on one or more of, or any combinations of, but not limited to: monitoring user's activity, contextual situation, one or more initial parameters of schedule, calendar, geo-spatial metrics and user's general behavior, user's fluency detection and the user's language being used along with content while interacting with other people via audio, video, and/or textual format, haptic user feedback which relates to the pressure being applied by the user entering keystroke or like, and/or input swiping speed.

The system and/or method may detect the user's or another user's impaired state while performing an activity on the device such as deleting a useful app (application) on the device. In such a case, since the activity is being monitored and the cognitive heuristics pattern has been established, the system and/or method is able to understand that the app or a set of apps the user or another user is trying to delete are a needed app being used on a daily basis. For instance, based on the relevance of one or more of those apps (applications) and their respective usage, and based on determining the state of the user, the system and/or method can create an overlay GUI encapsulating the app or the set of apps (or like framework) so that the app or set of apps is protected or locked and cannot be deleted, used, modified in any way.

In some embodiments, the system and/or method may adjust as to serve as multi-purpose protective agent, for example, including protection of one or more robotic devices and various applications. For example, the system and/or method may help prevent a user selecting one or more inappropriate or risky features on an app, for example, a selection related to touch malfunction on a mobile device that includes touch keys mapped to corresponding functions and a touch screen. Based on the cognitive states, the system and/or method may include displaying, or causing a displaying, a Graphic User Interface (GUI) screen; and deactivating at least a part of the area of the touch screen that is adjacent to, and/or associated with, the touch keys, so that part of the area of the touch screen cannot detect a touch gesture on the GUI screen. In this example, the system and/or method can prevent the execution of an undesired function caused by a user's simultaneous and unintentional touch on a touch panel (e.g., based on a user's history of device use, a user's current cognitive state, etc.)

In some embodiments, the system and/or method may include implementing or triggering a selectable lock to a GUI control, such as a close button based on the user's estimated cognitive state. For example, the lock can be imposed on an individual window. If desired, the lock can be password protected. After being applied, the system and/or method can provide an option to explicitly unlock the control before the control can be selected, which prevents inadvertent selections of the locked control. This feature may be triggered based on history and user state for one or more users. For example, a lock can be placed on a “close” control to prevent accidental closing of a window.

Based on a user's cognitive state, the system and/or method may estimate whether a contact with a touch area is intentional or unintentional, on the GUI element. The system and/or method may further disregard the user input by not activating the GUI if unintentional contact is indicated. By way of example, a finger may appear to be slipping between GUI elements and a user state appears to be distracted or not usual. Optionally, the system and/or method may further take into consideration a progressive feedback related to a time a GUI element is touched until the main action is invoked and initiate the main action only after a predetermined touch hold time threshold is reached. This timing and consideration may take into account at least history of use, the user cohort, and the user cognitive state. As an example, if a finger or a pointing device (or the like input device) appears to be crossing a logical barrier implemented by an application (e.g., a window of the application), the system and/or method (e.g., via a GUI) may disregard an action if the cognitive state is of a particular nature, and/or based on the past history of use.

In some embodiments, based on the cognitive state and/or the user cohort analysis, the system and/or method may cause the speed at which the graphical pointer traverses the GUI to be programmatically slowed, responsive to the user moving a pointing device (e.g., a finger, a mouse, joystick, track ball, etc.). Responsive to the pointing device exiting a region of the screen (to be protected or locked) and/or the cognitive state (which caused the slowing of the speed of the graphical pointer) changing, the graphical pointer speed may be restored to its prior setting.

Based on an estimate of the user state, the system and/or method may prompt the user for a confirmation to proceed with an interaction with a device. Thus, the system and/or method can provide a “self-protected” device or system based on the user mood or state such as a level of excitement, which can affect how the user interacts with a device or an apparatus, which can be expensive to replace, repair, and maintain.

The following illustrates additional example use cases of a “self-protection” enabled device. In the following examples, user cohort analysis, history, and risk levels may be learned:

An electronic toy device detects that a user is in bad mood, and the electronic toy device deactivates a chip. In another example, the electronic toy device can change its appearance or behavior to avoid calling the user's attention. User cohort analysis, history, and risk levels may be learned.

A bartender robot detects a customer misbehaving and shouting at it at the table, and the robot determines it is better to increase the distance at which it is programmed to approach the table.

A smart device may detect itself being shook, and/or sound and/or gestures outside of norm being made, while an app is being run (e.g., a game app). The smart device detects these activities and prioritizes bandwidth or another processor resource on the app (e.g., the game).

A vehicle driven by a driver detects driving behavior in running the car on a street, shifting, gestures and hands position on the steering wheel which indicate a reckless behavior. The vehicle may protect itself by adjusting one or more of its responsivity and actions.

The system and/or method in some embodiments allow a device to have a level of self-consciousness (or vigilance), for example, to determine that the device itself is in danger and to trigger one or more possible protection actions autonomously. An example may be an icon on a GUI that can be made to disappear responsive to detecting that the user's estimated cognitive level exceeds a threshold.

In some embodiments, a risk assessment further may determine the risk of damaging additional content based on the computed importance level of the content. If the risk level is deemed above a certain threshold, the system and/or method may automatically trigger an action generation module, which loads an action template from a local or remote device (or cloud-based device) storing action databases (e.g., removing icon from a GUI, removing features from an app, stopping email client to synchronize confidential email, requesting an approval from a third-party before taking an action, auto-deleting sensitive emails or contents, transferring sensitive content to a secondary computing device, etc.).

In some embodiments, a method of selecting (and prioritizing) one or more amelioration actions may further use a machine learning algorithm. Given an action space A, and a state space (situation) S, a machine learning algorithm, like artificial neural networks, can be used to estimate the confidence in the action(s) to be taken. Neural networks estimate parameters to choose a label (action). In this case, multiple labels (multi-class) can be estimated with confidence. If a set of actions are above thresholds, they are triggered.

An example of triggering an action can include, but is not limited to, removing a GUI icon. For example, remove a GUI icon, given a state space {User cognitive/behavior is “upset”, confidence: 0.8, Content risk factor: Medium, Location: Office, Surrounding threat level: Low, Device connected to network: Yes}.

The system and/or method determine a protective action such that the protective action can ensure device safety and have a minimal user service affect. Such a rule may be implemented as a rule of dynamic prioritization for the protective action. For example, a bartender robot should prefer to keep attending a customer who is misbehaving by increasing the robot's serving distance and modulating a voice tone rather than to stop serving the customer completely. The system and/or method may learn from past experience with the current customer or from similar customers, and if the customer's misbehavior further increases, the robot can determine to call a security personnel and/or stop serving the customer. The robot may also send a signal to and consult with a local or remote artificial intelligence (AI) service for suggestions on how to best handle an evolving situation. This AI service may make use of a “protection database” storing suggestions on how to handle different challenges. Such a database may evolve and can be shared or offered for sale.

In some embodiments, the system and/or method may try to identify if a change in a configuration may improve a user's misbehavior. The system and/or method can do this by analyzing user speech, eye tracking, and current user activity on a device or system. The system and/or method may extract entities, which can be the sources of the user's current behavior, and match the entities to system or device features, and may change those features, to ameliorate the user behavior. In some embodiments, eye tracking can be used to detect the source, for example, an element, part or app the user sees while engaging in the user's current behavior. Current user activity (e.g., use of a particular app) on a device or system can help in identifying the source of the user behavior. For example, an in-car smart assistant may change the tone or voice responsive to detecting user's frustration during an interaction.

In some embodiments, the system and/or method may estimate crowd density and crowd pressure, and if the density is high (e.g., compared to a threshold value), the system and/or method may cause the device to take a protection action which can be different from when the crowd density or crowd pressure is low (e.g., compared to a threshold value), for instance, which can protect both the device itself and the surrounding crowd. For example, a device implementing the method may estimate a risk for the device itself, for the user, and for the surrounding people, and based on the combined risk estimate, select a protection action (also referred to as amelioration action).

The following illustrates an example algorithm in one embodiment:

For each User Ui in a current detected list of users U (i being an index) {

- Get Ui characteristics: tone t, personality p, language expression l, facial gestures f, body

gesture and/or action b, Ui (t, p, l, g, b)

- Ui (t, p, l, g, b) is analyzed to determine cognitive state and behavior Ui (cs, be)
- If Ui (cs, be) surpass an initial warning threshold t_w, a self-protection monitoring session is

started for Ui and cohorts.

- For each history record Ui_Hj in Ui_H, (j being an index)

if Ui_Hj contains an old user cognitive state behavior Ui (cs, be) that triggered a violation to

the system that is similar to the current Ui (cs, be), then a self-protection monitoring session is
started for Ui and cohorts.
}
While self-protection monitoring session is active: {

- Continuously monitor Ui and cohorts. Get Ui characteristics: tone t, personality p, language

expression l, facial gestures f, body gesture and/or action b, Ui (t, p, l, g, b).

- Ui (t, p, l, g, b) is analyzed to determine cognitive state and behavior Ui (cs, be)
- If Ui (cs, be) surpasses a danger threshold t_d, then self-protection action is started.

}
If it is possible to detect a reason for deleterious action, then {

- Check components related to the reason.
- Change configuration on components.
- Measure Ui reactions to change.

}
If it is not possible to determine a reason, or configuration change has no positive effect, then {

- Get list of configured possible protective actions P_A.
- Each protective action P_Ak contains a set of machine comprehensible actions, a duration, a

prioritization, and a set of user cognitive states and behaviors Ux (cs, be) for which the P_Ak is
recommended, (k being an index).

- The prioritization in the P_Ak is used to set the order of protective actions in the order that

minimizes affectation to user usage.

- P_Ak is selected according to the current Ui (cs, be) and priority P_Ak_p.

}
After P_Ak execution duration, monitoring session continues.
If Ui (cs, be) is below warning threshold for a configured amount of time, the monitoring session
is finished.
Save session in use history Ui_H for future reference.

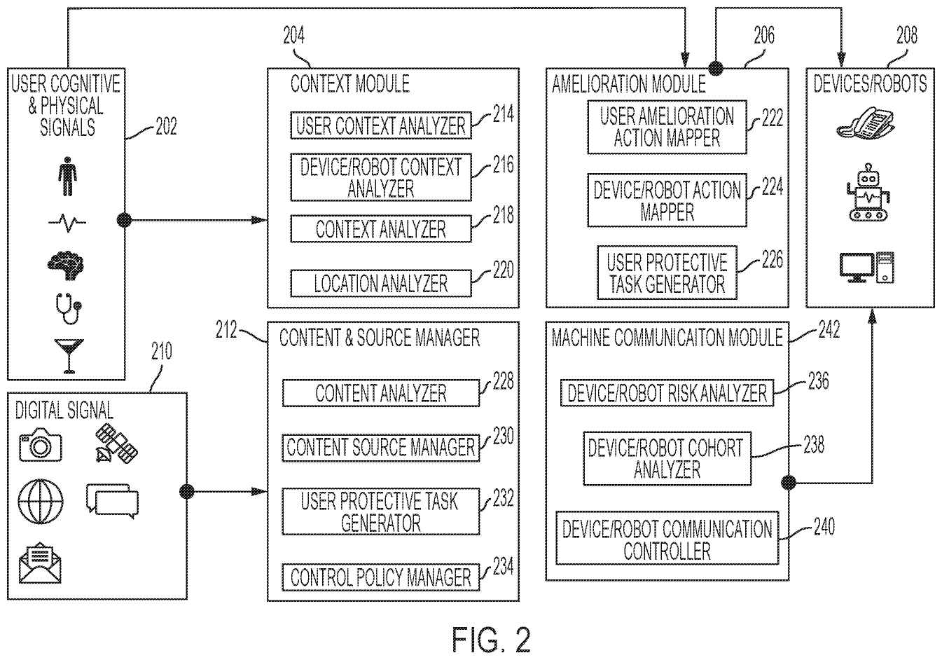

FIG. 2 illustrates system architecture in one embodiment for self-protection of a device or system performed based on prediction and contextual analysis. The components shown include computer-implemented components, for instance, implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

The system may take as input user's cognitive and physical signals along with the context, location, and other image, voice or textual information or messages to determine the context and risk level to determine one or more ameliorating actions to take and/or a specific action or task to relay to a device or robot to enact. In some embodiments, the system allows for device/robot to device/robot communication by sharing ameliorating actions and data about users or cohort and their associated risk levels.

Illustrated modules, e.g., a context module 204, amelioration module 206, content & source module 212 and machine communication module 242 may be computer modules, functions and/or instructions, for example, executing on one or more hardware processors. In an example, a context module 204 may receive as input user's cognitive and physical signals 202. The context module 204 may also receive context information such as current location of a user and/or a device, image, voice or textual information, which may indicate current characteristics of the user. The context module 204 may include functionalities such as a user context analyzer 214, a device context analyzer 216, a context analyzer 218, a location analyzer 220.

The user context analyzer 214 may take as input the user's context and activity (e.g., 202) and generate a series of probabilities of likely cognitive, emotional and activity states.

The device context analyzer 216 may take as input the state of the device and/or robot, interactions with the user and compute the device and/or robot's state through classifying the input signals (e.g., 210).

The context analyzer 218 may take input from the location analyzer 220, user context analyzer 214 and device/robot context analyzer 216, which may entail signals on the respective states and locational information, to classify the situational context and relative risk.

The location analyzer 220 may take as input data from GPS, accelerometer, historic user data, camera, microphone, etc., to determine the location of the device/robot and user.

The amelioration module 206 determine one or more ameliorating actions to take and/or a specific action or task to relay to a device to enact. Determined one or more ameliorating actions can be performed on the device 208. The amelioration module 206 may include functionalities such as a user amelioration action mapper 222, a device action mapper 224, and a user protective task generator 226.

The user amelioration action mapper 222 may take as input the context and risk level received from the context module 204 and generate one or more user amelioration actions which are actions that can be applied to move the user's state into a lower risk level. In one embodiment, the is can be computed using a rule-based mappings of specific context and risk levels to amelioration actions and/or a state graph where each node represents a user context and the amelioration action needed to move the user to a lower risk level node.

The device action mapper 224 may take as input the context and risk level received from the context module 204 and generate one or more device/robot actions which can be applied to reduce the potential danger or risk to the device/robot. This can entail moving the user's state into a lower risk level. This is computed using rule-based mappings of specific context and risk levels to amelioration actions and/or a state graph where each node represents a user context and the amelioration action needed to move the user to a lower risk level node.

The user protective task generator 226 may take as input the context and risk level received from the context module 204 and generate one or more user protective tasks such as removing an icon or features from the GUIs, generating a password, generating a snippets of information to change the emotional state of the user, etc. These protective tasks can be generated based on historic data of the follow-on tasks used historically or protectives actions based on the severity of the risk level (e.g., high-level risk may generate one or more tasks that are difficult to complete or one or more “soothing” tasks that seek to change the cognitive state of the user).

The content & source manager 212 may receive as input signals or information associated with content source, for example, email app, chat app, social network/media app, messaging app, and/or others. The content & source manager 212 may manage data or information from such sources for use in generating one or more protective tasks. The content & source manager 212 may include functionalities such as a content manager 228, a content source manager 230, a user protective task generator 232 and a control policy manager 234.

The content manager 228 may process the content from data sources such as camera, email, text messages, etc. and apply natural language understanding to generate signals such as sentiment, disposition, current task, which can be fed into the context module 204 and amelioration module 206. Standard models of sentiment analysis and task identification based on pre-trained models can be used.

The content source manager 230 may determine which set of processes to apply to a given set of data sources. For example, textual information from messages, email, etc., can be processed using natural processing techniques.

The user protective task generator 232 may control the specific tasks and recommendations made and may include a mapping of protective tasks and risk levels and contexts. Such a mapping can be used in the amelioration module 206 to retrieve corresponding user protective tasks based on the context, risk level and user state.

The control policy manager 234 may contain and manage a set of rules that determine the set of amelioration actions and protective tasks based on the risk level, context and user's cognitive state. This control policy manager can retrieve the relevant rules pertaining to the digital signals in 210.

The machine communication module 242 may determine a possible risk to the device and to one or more other devices, for example, based on user cognitive state and device context, and communicate the possible risk and/or the user cognitive state to one or more devices 208. The machine communication module 242 may include functionalities such as a device risk analyzer 236, a device cohort analyzer 238, and a device communication controller 240.

The device risk analyzer 236 may determine one or more possible risks to a device, for example, based on a user state and past history of user actions on the device. For example, a regression model, a neural network model, or another machine learning model trained using past history can be run. The device risk analyzer can compute the possible risk of damage or danger to nearby devices/robots.

The device cohort analyzer 238 may determine one or more possible risk to a device cohort, e.g., other similar devices, for example, based on a user state and past history of user actions on the device.

The device communication controller 240 may control information to communicate with one or more devices 208. For instance, the device communication controller 240 may facilitate sharing of information among devices 208, for example, to share information such as the user's state, one or more possible risks to one or more devices, and/or one or more amelioration actions taken on a device.

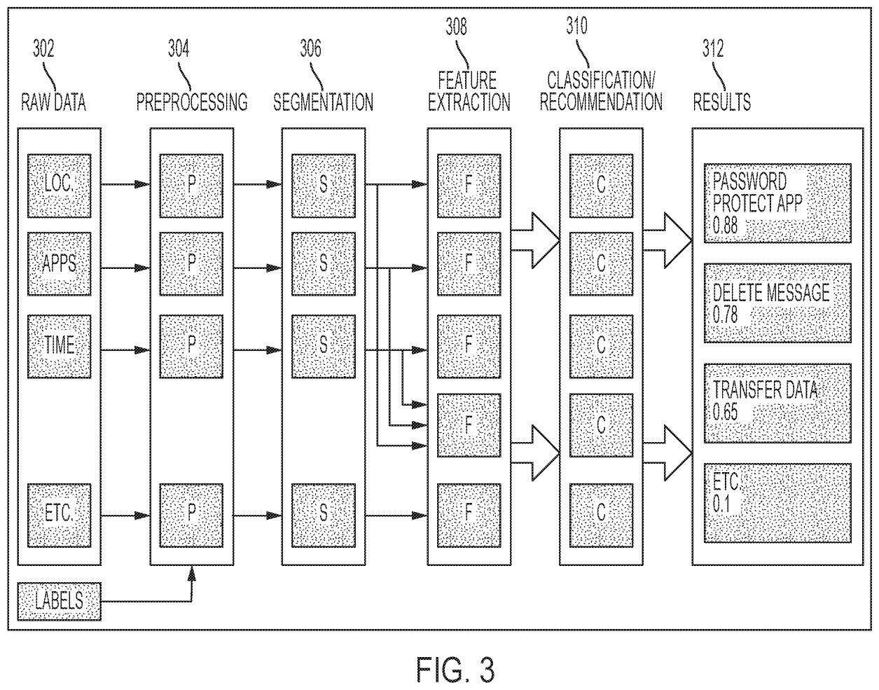

FIG. 3 illustrates an example of prediction phases and output in one embodiment. The figure illustrates in one embodiment a system's data processing, classification and generation of amelioration actions. Raw data 302 can be received and in a data preprocessing step 304, the received data can be labeled, for example, for preparation for supervised learning. A segmentation step 306 can segment the labeled data, for example, for preparation for supervised learning. A feature extraction step 308 can extract features from the labeled data, for example, for input to a classification model or algorithm. In an embodiment, if the data 302 is received as a training set, the features extracted can be used to train the classification model. In an embodiment, if the data 302 is received as a test set (e.g., unlabeled data whose label is to be predicted), a trained classification model can be run using the extracted features. A classification step 310, for example, runs the classification model, which can output results 312.

An example of a classifier or classification model can be an artificial neural network model, also referred to a neural network model. An embodiment of an implementation of an artificial neural network can include a succession of layers of neurons, which are interconnected so that output signals of neurons in one layer are weighted and transmitted to neurons in the next layer. A neuron Ni in a given layer may be connected to one or more neurons Nj in the next layer, and different weights wij can be associated with each neuron-neuron connection Ni-Nj for weighting signals transmitted from Ni to Nj. A neuron Nj generates output signals dependent on its accumulated inputs, and weighted signals can be propagated over successive layers of the network from an input to an output neuron layer. An artificial neural network machine learning model can undergo a training phase in which the sets of weights associated with respective neuron layers are determined. The network is exposed to a set of training data, in an iterative training scheme in which the weights are repeatedly updated as the network “learns” from the training data. The resulting trained model, with weights defined via the training operation, can be applied to perform a task based on new data.

In some embodiments, one or more devices and/or robots (e.g., directly connected to a system described above, or implementing a method for self-protection as described herein) can take the necessary amelioration actions to avoid damage and/or reckless action. Further, nearby devices and/or robots which may also face this risk can be protected. For example, through Bluetooth, Wi-Fi, near-field communication (NFC) or other communication medium, connected devices and/or robots can relay one or more user risk assessments and ameliorating actions to follow. For example, user A's smartphone senses given the time of day, the user's recent location and the user's tone of voice that indicates that the user is inebriated and therefore a high risk, and so blocks one or more GUI icons. User A's cognitive state and ameliorating action is then relayed to User A's laptop via Bluetooth so the user's A's laptop can also enact one or more ameliorating actions. In another example, robot assistants are engaging a cohort of customers when they start misbehaving. A robot takes one or more ameliorating actions by moving away from the cohort of customers and sends a signal to other nearby one or more robots the risk assessment of the cohort so that the nearby one or more robots can also take one or more ameliorating actions.

In some embodiments, a device or robot can use the facial expression, context and any real-time measuring data of the user's to process and generate “soothing actions,” which can be an atomic set of actions or snippets of information to change the emotional state of the user. Examples of soothing actions can include, but is not limited to: calming music, inspirational quotes, and images.

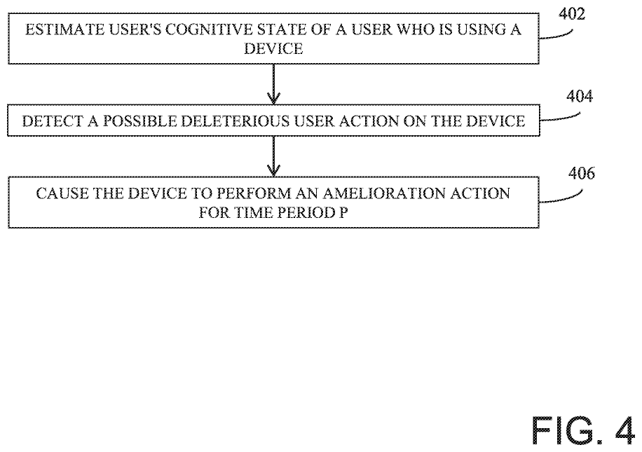

FIG. 4 is a flow diagram illustrating a method in one embodiment. The method may automatically detect and take an action to protect a device from one or more deleterious user actions based on prediction and contextual analysis. The method may be performed by at least one hardware processor. At 402, the method includes estimating a user's cognitive state and/or behavior who is using a device. The device for example can be a smartphone or another smart device, a laptop and or another computer-implemented device. The user's cognitive state can be estimated based on reading or detecting user facial expression captured via an image capturing device such as a camera, detecting voice volume, tone or another speech attribute if available, and body gesture if available, and/or another characteristic. For instance, such estimation may be performed based on characteristics of the user captured via a component such as a camera (or another image capturing component), voice or sound capturing component, and/or another component.

At 404, the method includes, based on past history of use of the device and the detected user's cognitive state, detecting a possible deleterious user action on the device for example, by this particular user, or for example, by a user cohort having similar characteristics as the user.

At 406, based on the detected possible deleterious user action on the device, the method includes performing an amelioration action (e.g., a self-protection action) for the device for time period P. The time duration (e.g., time period P) of the amelioration may be determined based on one or more of estimated potential danger to the device, continuation of a dangerous user state (e.g., while the user state exceeds a threshold value), estimation of the level of cognitive or behavioral concern. In one embodiment, the method can be performed by the device itself. In another embodiment, the method can be performed by a computer or processor operatively connected to the device and cause the device to perform the amelioration action to protect itself.

In some embodiments, the hardware processor performing the method may be part of the device. In some embodiments, the hardware processor performing the method may be a computer processor communicatively coupled with the device. In some embodiments, performing an amelioration action includes causing the device to perform the amelioration action. In some embodiments, performing an amelioration action may include the hardware processor performing the amelioration action on the device.

Examples of the cognitive state or behavior include, but are not limited to, the state of being upset, excited, a level of distraction, disregard for the device's “wellbeing,” inebriation, drowsiness, and/or others.

The method may also include generating an optimal set of amelioration actions based on at least one optimization objective. Examples of the generated set of amelioration actions, may include, but are not limited to: basic actions, advanced actions, and soothing actions. Examples of basic actions may include but are not limited to: an icon being removed from a GUI, features being removed from an app, features being deactivated for a time period, features being password protected, features being shielded in a robot embodiment, removing apps or apps' shortcuts from locations that can be easily accessible, removing sensitive contents (e.g., emails, documents, data), and hiding content, icon, item, and/or others.

Examples of advanced actions may include, but are not limited to: asking for a password responsive to detecting a user attempting to access a GUI button or icon while in a estimated cognitive state that exceeds a threshold level, for an app, content on the device; encrypting content based on risk factor of the content; transferring content to a secondary computing device; stopping synchronizing of on-device content associated with content sources and/or apps with remote content sources and/or apps; hiding content arrivals (e.g., deactivating notifications); transferring content to other content formats, at least for a period of time P (e.g., by blurring image, deducing quality of the content, etc.). Examples of soothing actions may include, but are not limited to: atomic set of actions or snippets of information to change the emotional state of the user such as but not limited to, calming music, inspirational quotes, and images.

In some embodiments, the method may determine the period of time, T based on one or more of estimated danger to the device, continuation of a dangerous user state, estimation of level of cognitive or behavioral concern, and/or others. Similarly, the time period P can be based on one or more of estimated danger to the device, continuation of a dangerous user state, estimation of level of cognitive or behavioral concern, and/or others.

Examples of the device may include, but are not limited to a smartphone, an app running on a smartphone, a device embodied as a service robot, toy, robot, car, autonomous vehicle, medical device, word processor app, web browser, and/or others. In some embodiments, the method can enable the device to share the user's cognitive state and the amelioration action the device has taken with one or more other devices, e.g., via Bluetooth, Wi-Fi, NFC, etc., to mitigate further damage to other one or more devices, robots, cars, etc.

The deleterious user action may include one or more actions, which may lead to a system or device inefficiency, destruction, or the like. The past history of actions may be stored in a database.

In some embodiments, a timer or decay curve controls the time when a removed feature (performed as part of the amelioration action) can be presented or popped back into existence or when a self-protection feature (performed as part of the amelioration action) can be relaxed, with the decay rate depending on nature of the feature, user cohort analysis, user history, or cohort history.

In some embodiments, the method can allow a user to override the self-protection performed on the device. For example, the user may control whether a removed feature or a deactivated feature or a hidden feature should be returned back to normal state immediately.

In some embodiments, the amelioration action may include selecting one or more GUI icons to remove from a set of possible icons. Such selection can be based on a risk assessment relating to possible use of those icons.

In some embodiments, the method may estimate a cognitive state by any one or more of: facial expression analysis, distraction analysis (e.g., user has 10 open windows and is talking on the phone).

In some embodiments, the method may learn the cognitive state a plurality of user activities, for example, based on analysis of messages, notifications, emails received, joint analysis of phone calls received, etc. The method may further learn and/or estimate the user cognitive state or behavior from user situational context. Such user situational context may include predicting a user entering an interaction or conversation at particular time of the day, sensing the user's excited behavior based on voice or speech recognition, and/or a crowd density, crowd sensing technique, and/or others.

In some embodiments, detecting situational context of the user and user cognitive context may involve further analyzing data received from a plurality of data sources such as mobile device built-in sensor (e.g., GPS, accelerometer, camera, microphone, etc.), crowd-sourced location information, data received from a nearby computing device (e.g., one or more nearby mobile devices) and/or data a communication device (e.g., one or more of Wi-Fi gateway, Beacon, network device, etc.) can capture (e.g., via a camera, microphone), etc. In some embodiments, the method may include learning user's actions based on dynamic keyboard strokes while engaging with his/her mobile/laptop/wearable device.

The estimated user's cognitive state and the amelioration action can be shared with another device, for instance, via a communication network. In some embodiments, a protocol may be used for the device to share the user's cognitive state and the amelioration action the device has taken with one or more devices, for example, to prevent damage to those one or more devices. Examples of a protocol for sharing information between devices may include, but are not limited to, machine to machine (M2M) communication protocol which can occur via wireless communications, Representational State Transfer (REST) Application Programming Interface (API), and/or Message Queuing Telemetry Transport (MQTT) protocol.

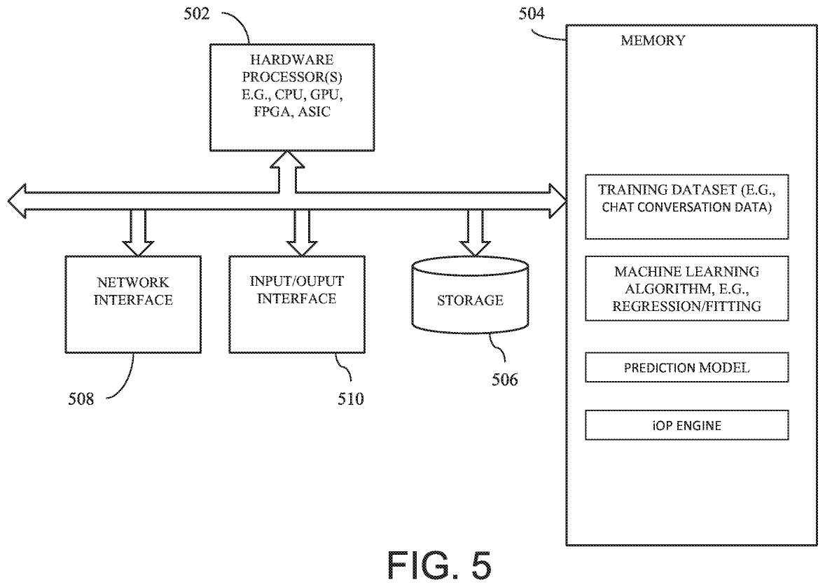

FIG. 5 is a diagram showing components of a system in one embodiment that can provide device protection, for example, a self-protection. One or more hardware processors 502 such as a central processing unit (CPU), a graphic process unit (GPU), and/or a Field Programmable Gate Array (FPGA), an application specific integrated circuit (ASIC), and/or another processor, may be coupled with a memory device 504, and detect a user cognitive state, which may be associated with a possible user action on a device, which may cause inefficiency and/or deleterious effect on the device. A memory device 504 may include random access memory (RAM), read-only memory (ROM) or another memory device, and may store data and/or processor instructions for implementing various functionalities associated with the methods and/or systems described herein. One or more processors 502 may execute computer instructions stored in memory 504 or received from another computer device or medium. A memory device 504 may, for example, store instructions and/or data for functioning of one or more hardware processors 502, and may include an operating system and other program of instructions and/or data. One or more hardware processors 502 may receive input comprising chat space conversation data. For instance, at least one hardware processor 502 may estimate a user's cognitive state of a user who is using a device. At least one hardware processor 502 may, based on past history of use of the device and the estimated user's cognitive state, detect a possible deleterious user action on the device. At least one hardware processor 502 may, based on the detected possible deleterious user action on the device, cause the device to perform an amelioration action for time period P. In one aspect, data used by at least one hardware processor 502 may be stored in a storage device 506 or received via a network interface 508 from a remote device, and may be temporarily loaded into a memory device 504. One or more hardware processors 502 may be coupled with interface devices such as a network interface 508 for communicating with remote systems, for example, via a network, and an input/output interface 510 for communicating with input and/or output devices such as a keyboard, mouse, display, and/or others.

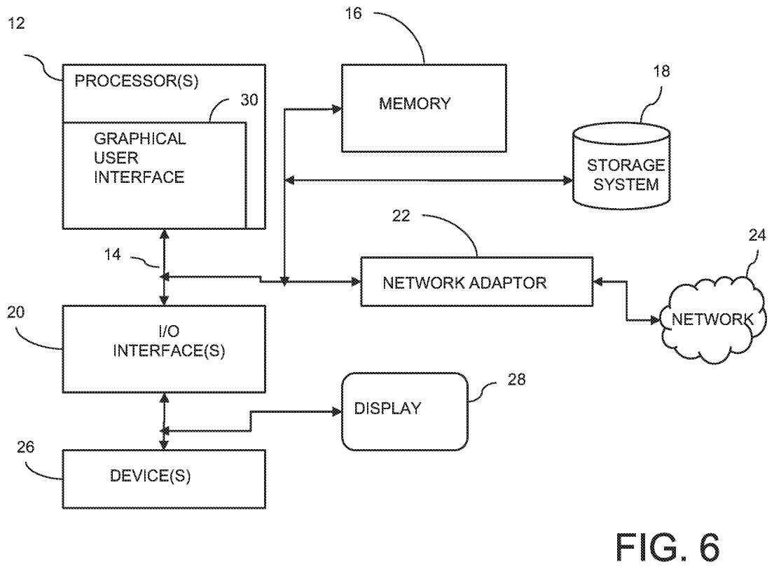

FIG. 6 illustrates a schematic of an example computer or processing system that may implement a system according to an embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

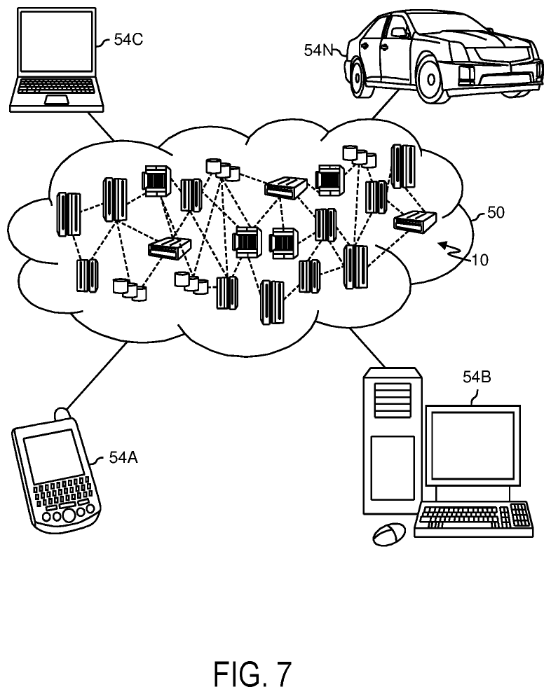

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

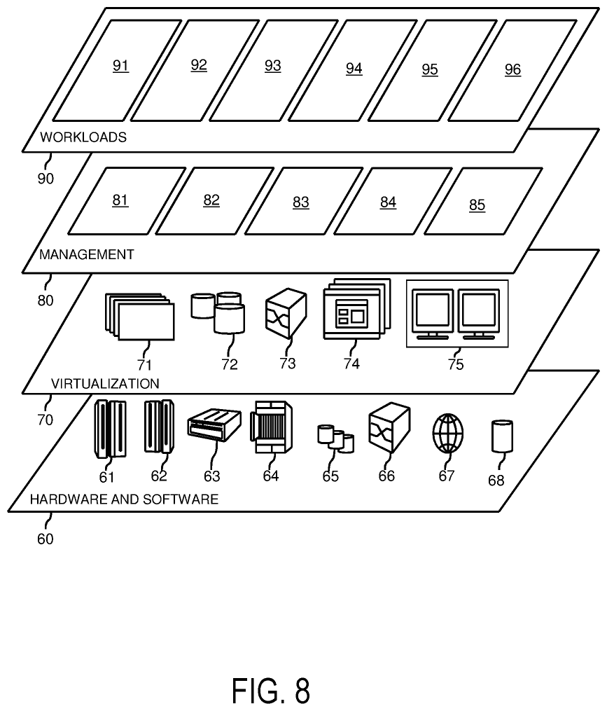

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and device protection processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

What is claimed is:

1. A system comprising:
a hardware processor;
a memory device operably coupled to the hardware processor;
the hardware processor operable to at least perform:
estimate a user's cognitive state of a user who is using a device;
based on past history of use of the device and the estimated user's cognitive state, detect a possible deleterious user action on the device;
based on the detected possible deleterious user action on the device, cause the device to perform an amelioration action for a time period P.

2. The system of claim 1, wherein the hardware processor is part of the device.

3. The system of claim 1, wherein the hardware processor is communicatively coupled to the device.

4. The system of claim 1, wherein the user's cognitive state is determined based on at least current characteristics captured of the user.

5. The system of claim 1, wherein the amelioration action includes at least deactivating a feature on the device.

6. The system of claim 1, wherein the amelioration action includes at least password protecting a feature on the device.

7. The system of claim 1, wherein the amelioration action includes at least requesting a challenge test to be performed in accessing a feature on the device.

8. The system of claim 1, wherein the amelioration action includes at least hiding an icon on a graphical user interface associated with the device.

9. The system of claim 1, wherein the amelioration action includes at least playing music.

10. The system of claim 1, wherein the time period is determined based on at least a duration of the estimated user's cognitive state associated with the possible deleterious user action on the device.

11. The system of claim 1, wherein the hardware processor allows for overriding of the amelioration action.

12. The system of claim 1, wherein the hardware processor shares the estimated user's cognitive state and the amelioration action with another device via a communication network.

13. A computer-implemented method comprising:
estimating a user's cognitive state of a user who is using a device;
based on past history of use of the device and the detected user's cognitive state, detecting a possible deleterious user action on the device;
based on the detected possible deleterious user action on the device, causing performing of an amelioration action for a time period P.

14. The computer-implemented method of claim 13, wherein the user's cognitive state is determined based on at least current characteristics captured of the user.

15. The computer-implemented method of claim 13, wherein the amelioration action includes at least deactivating a feature on the device.

16. The computer-implemented method of claim 13, wherein the amelioration action includes at least password protecting a feature on the device.

17. The computer-implemented method of claim 13, wherein the amelioration action includes at least requesting a challenge test to be performed in accessing a feature on the device.

18. The computer-implemented method of claim 13, wherein the time period is determined based on at least a duration of the estimated user's cognitive state associated with the possible deleterious user action on the device.

19. The computer-implemented method of claim 13, wherein the hardware processor shares the estimated user's cognitive state and the amelioration action with another device via a communication network.

20. A computer program product comprising a computer readable storage medium having program instructions embodied therewith, the program instructions executable by a computer processor to cause the computer processor to:
estimate a user's cognitive state of a user who is using a device;
based on past history of use of the device and the estimated user's cognitive state, detect a possible deleterious user action on the device;
based on the detected possible deleterious user action on the device, cause the device to perform an amelioration action for a time period P.
